(19) United States
(12) Patent Application Publication
(10) Pub. No.: US 2013/0323951 A1
(43) Pub. Date: Dec. 5, 2013

(54) ADAPTOR FOR CONNECTING CONNECTORS WITH DIFFERENT INTERFACES

(71) Applicants: Wang-I YU, Jhonghe (TW); Hung-Chi TAI, Jhonghe (TW); Yong-Gang ZHANG, Taicang (CN)

(72) Inventors: Wang-I YU, Jhonghe (TW); Hung-Chi TAI, Jhonghe (TW); Yong-Gang ZHANG, Taicang (CN)

(73) Assignee: ALLTOP ELECTRONICS (SUZHOU) LTD., Taicang City (CN)

(21) Appl. No.: 13/585,511

(22) Filed: Aug. 14, 2012

(30) Foreign Application Priority Data
May 30, 2012 (CN) 201210172378.0

(51) Int. Cl. H01R 27/00

(52) U.S. Cl. 439/218

(57) ABSTRACT

An adaptor, for connecting two electrical connectors with different interfaces, has a first connector, a second connector and a connecting means connecting the first connector and the second connector. The first connector includes a first insulating housing and first contacts received in the first insulating housing. The second connector includes a second insulating housing and second contacts received in the second insulating housing. The first connector has a pair of receiving openings. The first contacts have a first group of contacts and a second group of contacts. The first group of contacts and the second group of contacts are respectively received in the pair of receiving openings.

### BACKGROUND OF THE INVENTION

1. Field of the Invention

The present invention relates to an electrical connector, and more particularly to an adaptor for connecting connectors with different interfaces.

2. Description of Related Art

USB connectors are widely used in digital products including computer, digital camera, or portable communications terminals. With the development of the technology, the USB connector is updated from 2.0 version to 3.0 version and the corresponding transmission rate is updated from 480 Mbps up to 3.2 Gbps. Nowadays, portable devices such as laptops and cellular phones are designed more and more compact to facilitate the storage and carrying thereof. Therefore, Micro-USB connectors are developed and are more compact when compared to the USB 3.0 connectors so that the Micro-USB 3.0 connectors may be easily assembled on the portable electronic devices.

Hence, it is desirable to provide a adaptor for connecting two electrical connectors with different USB 3.0 interfaces.

### BRIEF SUMMARY OF THE INVENTION

The present invention provides an adaptor, adaptor for connecting two electrical connectors with different interfaces, comprises a first connector, a second connector and a connecting means connecting the first connector and the second connector. The first connector comprises a first insulating housing and a plurality of first contacts received in the first insulating housing. The second connector comprises a second insulating housing and a plurality of second contacts received in the second insulating housing. The first connector comprises a pair of receiving openings. The first contacts comprise a first group of contacts and a second group of contacts. The first group of contacts and the second group of contacts are respectively received in the pair of receiving openings.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an adaptor in accordance with a first embodiment of the present invention;

FIG. 2 is a perspective view of the adaptor shown in FIG. 1 while taken from another aspect;

FIG. 3 is a perspective view of the adaptor shown in FIG. 1 without an upper shell;

FIG. 4 is a perspective view of the adaptor shown in FIG. 2 without the upper shell;

FIG. 5 is an exploded, perspective view of the adaptor shown in FIG. 1;

FIG. 6 is an exploded, perspective view of the adaptor shown in FIG. 2;

FIG. 7 is a perspective view of the adaptor of a second embodiment of the present invention;

FIG. 8 is a perspective view of the adaptor shown in FIG. 7 while taken from another aspect;

FIG. 9 is a perspective view of the adaptor shown in FIG. 7 without the upper shell; and

FIG. 10 is a perspective view of the adaptor shown in FIG. 8 without the upper shell.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

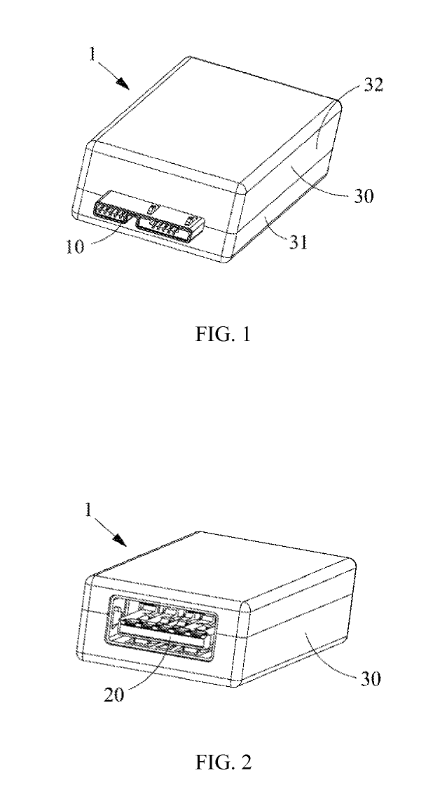

Referring to FIG. 1 to FIG. 4, the adaptor 1 in accordance with the present invention is used for electrically connecting two electrical connectors with different interfaces. The adaptor 1 comprises a first connector 10, a second connector 20, a connecting means 40 for connecting the first connector 10 and the second connector 20, and a plastic shell 30 covering the first connector 10, the second connector 20, and the connecting means 40. The plastic shell 30 is composed by a lower shell 31 and an upper shell 32. In the present invention, the first connector 10 is compliant with Micro USB 3.0 standard, and the second connector is compliant with USB 3.0 standard.

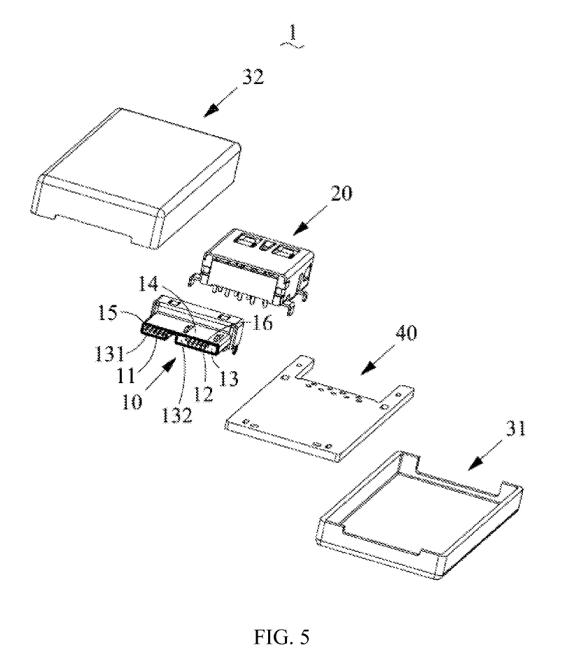

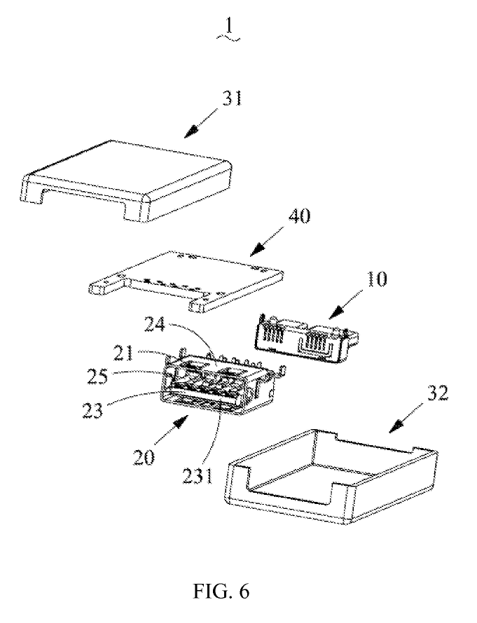

Referring to FIGS. 5 and 6, in the first preferred embodiment, the first connector 10 has first contacts 11, 12, a first insulating housing 13 receiving the first contacts 11, 12, and a first metal shield 14 covering the first contacts 11, 12 and the first insulating housing 13. The first connector 10 has a pair of receiving openings, which are first receiving opening 15 and second receiving opening 16. The first receiving opening 15 and the second receiving opening 16 are defined by the first metal shield 14. The first receiving opening 15 communicates with the second receiving opening 16. The first insulating housing 13 of the first connector 10 comprises a first mating tongue 131 and a second mating tongue 132. The first mating tongue 131 and the second mating tongue 132 are received in corresponding first receiving opening 15 and second receiving opening 16. In the preferred embodiment, the first contacts include a first group of contacts 11 and a second group of contacts 12. The first group of contacts 11 is assembled on the first mating tongue 131, and the second group of contacts 12 is assembled on the second mating tongue 132. The first connector 10 partially extends outside of the lower shell 31 and the upper shell 32 to thereby mating with a complementary receptacle connector. In the present invention, the first connector 10 is a plug connector and is compliant with Micro USB 3.0 standard.

In the first embodiment, the second connector 20 comprises second contacts 21, a second insulating housing 23 receiving the second contacts 21, and a second metal shield 24 covering the second contacts 21 and the second insulating housing 23. The second metal shield 24 defines a receiving cavity 25. The second insulating housing 23 includes a tongue portion 231 extending within the receiving cavity 25. The second contacts 21 are partially assembled on the tongue portion 231 for electrically connecting with a complementary plug connector. In the present invention, the second connector 20 is a receptacle connector and is compliant with USB 3.0 standard.

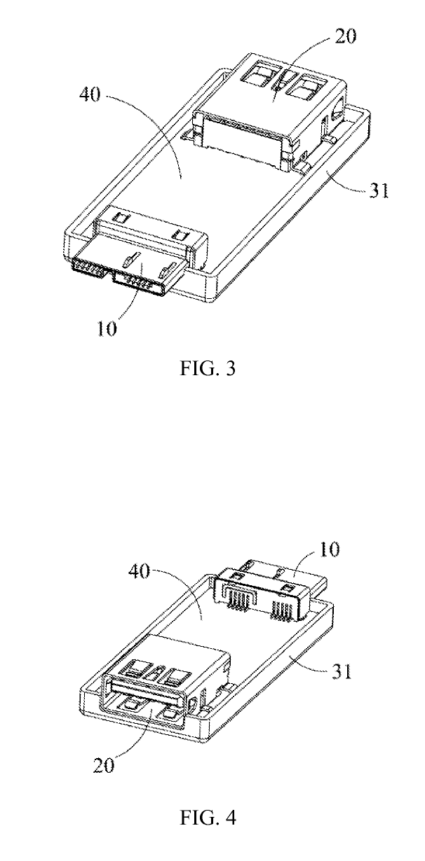

Turning to FIGS. 3-6, in the first embodiment, the connecting means 40 is a printed circuit board. The printed circuit board 40 has a plurality of connecting circuits and golden fingers for electrically connecting the first contacts 11, 12 and the second contacts 21. The printed circuit board 40 is a conventional board. Details of the printed circuit board are therefore not provided hereby. As can be easily understood, the connecting means 40 can be also a cable having a plurality of wires. Any element or device which can be used for electrically connecting the first connector 10 and the second connector 20 is the connecting means 40 of the present invention.

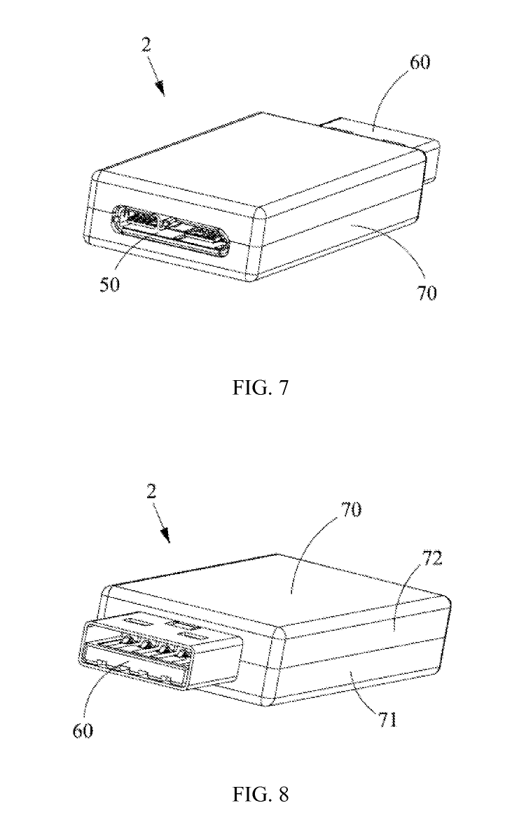

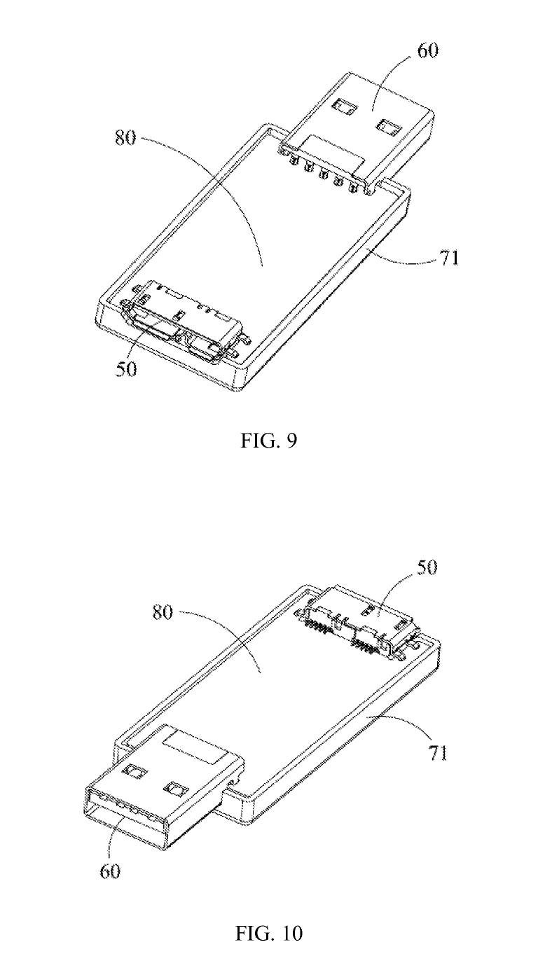

Referring to FIGS. 7-10, in the second embodiment of the present invention, similarly, the adaptor 2 comprises a first connector 50, a second connector 60, a connecting means 80 connecting the first connector 50 and the second connector 60, and a plastic shell 70 enclosing the first connector 50, the second connector 60 and the connecting means 80. The plastic shell 70 is composed by a lower shell 71 and an upper shell 72. In the second embodiment, the first connector 50 is a receptacle connector and is compliant with Micro USB 3.0 standard and the second connector 60 is a plug connector and is compliant with USB 3.0 standard.

As a whole, the present invention employs the adaptor 1, 2, which has Micro USB 3.0 interface connector 10, 50, to quickly connect the complementary Micro USB 3.0 connector and the complementary USB 3.0 connector.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. An adaptor for connecting two electrical connectors with different interfaces, comprising:
a first connector, said first connector comprising a first insulating housing and a plurality of first contacts received in said first insulating housing;
a second connector, said second connector comprising a second insulating housing and a plurality of second contacts received in said second insulating housing; and
a connecting means electrically connecting said first connector and said second connector;
wherein said first connector comprises a pair of receiving openings;
wherein said plurality of first contacts comprise a first group of contacts and a second group of contacts, and wherein said first group of contacts and said second group of contacts are respectively received in said pair of receiving openings.

2. The adaptor connector as claimed in claim 1, wherein said first connector comprises a metal shield covering said first group of contacts and said first insulating housing, and wherein said pair of receiving openings are defined by said metal shield.

3. The adaptor connector as claimed in claim 2, wherein said pair of receiving openings communicate with each other.

4. The adaptor connector as claimed in claim 3, wherein said first insulating housing comprises a first mating tongue and a second mating tongue, and wherein said first group of contacts are partially assembled on said first mating tongue and said second group of contacts are partially assembled on said second mating tongue.

5. The adaptor connector as claimed in claim 1, further comprising an upper shell and a lower shell, and wherein said first connector, said second connector and said connecting means are assembled between said upper shell and said lower shell.

6. The adaptor connector as claimed in claim 1, wherein said connecting means is a printed circuit board.

7. The adaptor connector as claimed in claim 1, wherein said connecting means is a group of wires.

8. The adaptor connector as claimed in claim 6, wherein said first connector is compliant with Micro USB 3.0 standard.

9. The adaptor connector as claimed in claim 8, wherein said second connector is compliant with USB 3.0 standard.

10. The adaptor as claimed in claim 7, wherein said first connector is compliant with Micro USB 3.0 standard.

11. The adaptor as claimed in claim 10, wherein said second connector is compliant with USB 3.0 standard.

12. The adaptor as claimed in claim 6, wherein said first connector is a plug connector, and said second connector is a receptacle connector.

13. The adaptor as claimed in claim 7, wherein said first connector is a plug connector, and said second connector is a receptacle connector.

14. The adaptor as claimed in claim 6, wherein said first connector is a receptacle connector, and said second connector is a plug connector.

15. The adaptor as claimed in claim 7, wherein said first connector is a receptacle connector, and said second connector is a plug connector.
